(19) United States
(12) Patent Application Publication
(10) Pub. No.: US 2007/0076362 A1
(43) Pub. Date: Apr. 5, 2007

(54) Computer device having multi-function handle

(76) Inventor: Isaac Lagnado, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/240,144

(22) Filed: Sep. 30, 2005

(51) Int. Cl. G06F 1/16

(52) U.S. Cl. 361/683

(57) ABSTRACT

A computer device comprising a handle usable to transport the computer device, the handle configured having a storage cavity disposed therein.

### BACKGROUND OF THE INVENTION

Computer devices such as notebook or laptop computers are becoming increasingly smaller. Because of the decreased sizes of such computer devices, internal space for operational components has been reduced. As a result, particular operational components must be mounted in close proximity to other operational components which may adversely affect performance of such components and/or cause damage to the components during installation.

### BRIEF DESCRIPTION OF THE DRAWINGS

For a more complete understanding of the present invention, and the objects and advantages thereof, reference is now made to the following descriptions taken in connection with the accompanying drawings in which:

FIG. 1 is a perspective view of an embodiment of a computer device having a multi-function handle in accordance with the present invention;

FIG. 2 is a perspective view of another embodiment of a computer device having a multi-function handle in accordance with the present invention;

FIG. 3 is a diagram illustrating a portion of another embodiment of a computer device comprising a multi-function handle in accordance with the present invention;

FIG. 4 is a diagram illustrating a portion of another embodiment of a computer device comprising a multi-function handle in accordance with the present invention; and

FIG. 5 is a diagram illustrating a portion of yet another embodiment of a computer device comprising a multi-function handle in accordance with the present invention.

### DETAILED DESCRIPTION OF THE DRAWINGS

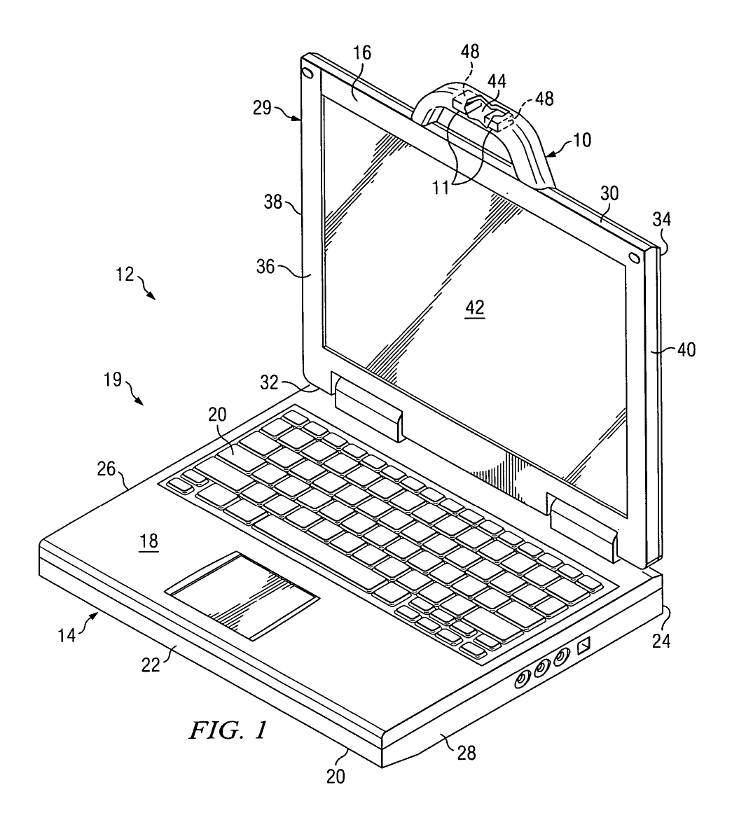

The preferred embodiments of the present invention and the advantages thereof are best understood by referring to FIGS. 1-5 of the drawings, like numerals being used for like and corresponding parts of the various drawings.

FIG. 1 is a diagram illustrating an embodiment of a computer device 12 having a multi-function handle 10 in accordance with the present invention. In the embodiment illustrated in FIG. 1, computer device 12 comprises a laptop or notebook computer 13. However, it should be understood that computer device 12 may comprise other types of devices such as, but not limited to, a tablet personal computer, personal digital assistant, or other type of computer device. Multi-function handle 10 is adapted to house operational component(s) 11 of computer device 12 and/or other items that are associated with the use of computer device 12 (e.g., an electronic pen or pointing device) or used independently of computer device 12 (e.g., a writing instrument such as a pencil or a spare battery) while enabling a user to easily carry or transport computer device 12 via handle 10.

In the embodiment illustrated in FIG. 1, computer device 12 comprises a base member 14 rotatably coupled to a display member 16. Base member 14 comprises a housing 19 having a working surface 18, a bottom wall 20, a front wall 22, a rear wall 24 and a pair of sidewalls 26 and 28. Display member 16 comprises a housing 29 having a front wall 30, a rear wall 32, a top wall 34, a bottom wall 36 and a pair of sidewalls 38 and 40. The display member 16 supports and/or otherwise houses a display screen 42, such as a liquid crystal display (LCD).

According to the embodiment illustrated in FIG. 1, multi-function handle 10 is coupled to display member 16. In the embodiment illustrated in FIG. 1, handle 10 is formed integral with front wall 30 of display member 16 (i.e., formed as a single, unitary or continuous structure). However, it should be understood that handle 10 can be configured to be removably couplable to display member 16 and/or disposed at any position on display member 16 (e.g., on walls 32, 34, 36, 38 and/or 40 or any combination thereof). Furthermore, it should be understood that handle 10 can be formed integral or separately couplable to base member 14 and disposed at any position on base member 14 (e.g., on walls 18, 20, 22, 24, 26 and/or 28 or any combination thereof).

In the embodiment illustrated in FIG. 1, handle 10 comprises a cavity 44 for housing operational component(s) 11 of computer device 12 and/or other items. For example, in the embodiment illustrated in FIG. 1, operational component(s) 11 comprises antenna(s) 48 to facilitate wireless communications to and/or from computer device 12, such as a radio frequency (RF) antenna, a planar inverted f-antenna (PIFA), or a loop type antenna, by way of example, coupled to corresponding internal circuitry of computer device 12. However, it should be understood that operational component(s) 11 may comprise any other type of operational component of computer device 12 such as, but not limited to, a power source, a speaker, a microphone, or a light emitting diode for indicating an operational status condition.

In the embodiment illustrated in FIG. 1, handle 10 is disposed on front wall 30 of display member 16 so that when computer device 12 is configured in the open position (e.g., where display member 16 is disposed generally upright with respect to base member 14 as illustrated in FIG. 1), cavity 44, and thus antenna 48, are positioned at an elevated position (e.g. the highest point of computer device 12) to enhance the performance of antenna 48. When computer device 12 is in the closed position (e.g., when display member 16 is disposed adjacent and parallel to base member 14), handle 10 is usable to transport computer device 12.

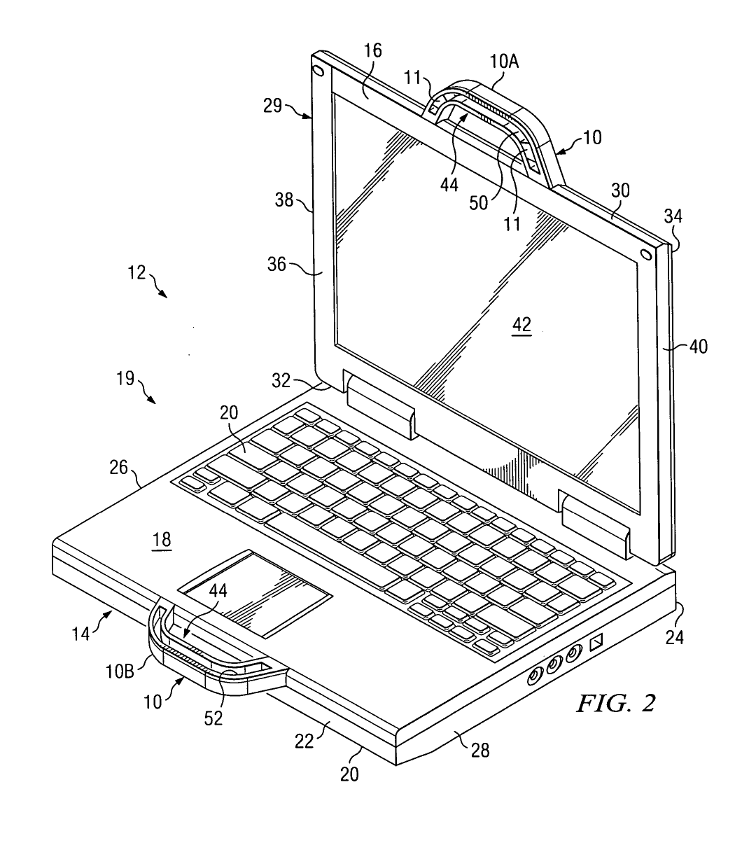

FIG. 2 is a diagram illustrating another embodiment of computer device 12 having multi-function handle 10 in accordance with the present invention. In the embodiment illustrated in FIG. 2, handle 10 comprises a first portion 10A disposed on display member 16 and a second portion 10B disposed on base member 14. First and second portions 10A and 10B each comprise a recessed area 50 and 52, respectively, such that when base and display members 14 and 16 are in the closed position, first and second portions 10A and 10B cooperate with each other to form cavity 44 within handle 10 for operational component(s) 11 of computer device 12 and/or for various other types of items such as, but not limited to, a computer pen, writing utensil, or spare battery.

Preferably, handle 10 is positioned and/or otherwise configured to extend outwardly from housing 19 and/or 29 to provide cavity 44 as a storage area sufficiently sized to accommodate desired operational component(s) 11 of computer device 12 and/or other items. Further, configuring handle 10 to extend outwardly from housing 19 and/or 29 substantially reduces or eliminates disturbance and/or interference (e.g., electromagnetic interference and/or other types of electronic and/or signal disturbances) between operational component(s) 11 disposed within handle 10 and other components of computer device 12 (e.g., display screen 42). In addition, configuring handle 10 external to housing 19 and/or 29 facilitates placement of operational component(s) 11 within handle 10 that may otherwise be stored within housing 19 and/or 29, thereby resulting in additional storage space within housing 19 and/or 29 and/or facilitates a reduced size of housing 19 and/or 29. However, it should be understood that computer device 12 and/or handle 10 may be otherwise manufactured.

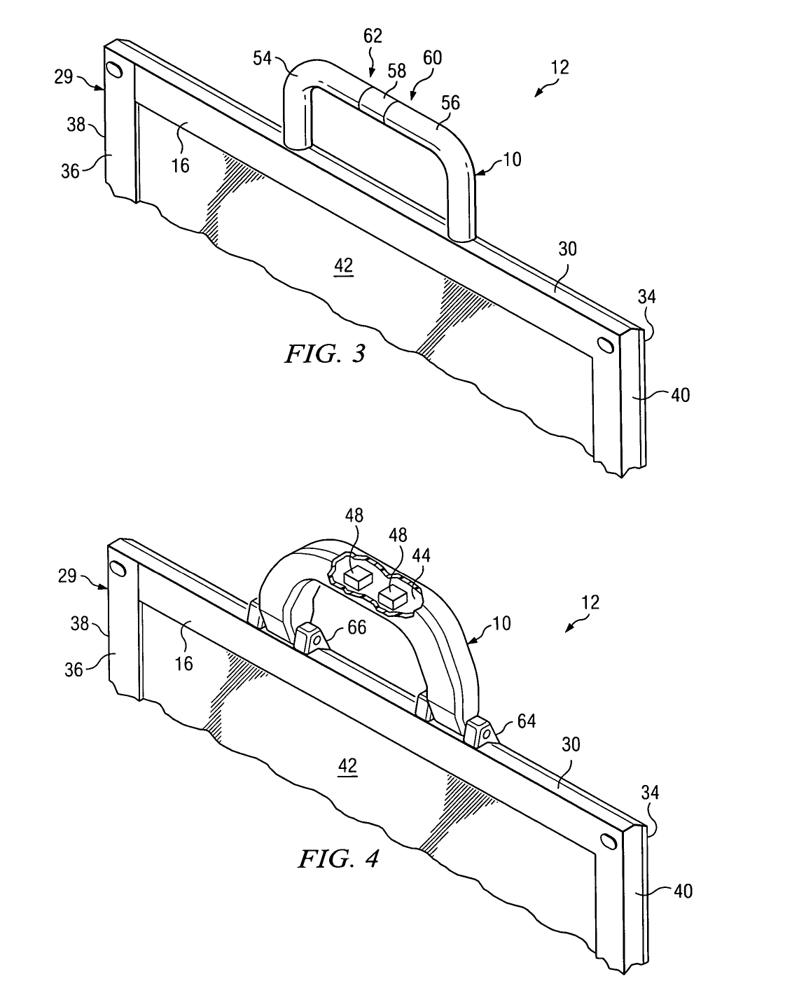

FIG. 3 is a diagram illustrating a portion of another embodiment of computer device 12 comprising multi-function handle 10 in accordance with the present invention. In the embodiment illustrated in FIG. 3, at least a portion of handle 10 is configured as an antenna (i.e., functions as an antenna of computer device 12). For example, in the embodiment illustrated in FIG. 3, handle 10 comprises antennas 54 and 56 each communicatively coupled to corresponding electronic circuitry within computer device 12 to accommodate transmission/reception of wireless communications. In the embodiment illustrated in FIG. 3, handle 10 comprises a spacer element 58 disposed between an end 60 of antenna 56 and an end 62 of antenna 54 to configure handle 10 as a continuous element and/or provide a gap and/or predetermined distance between antennas 56 and 54. However, it should be understood that handle 10 may be configured without spacer element 58 (e.g., in embodiments where handle 10 is configured as a single antenna or if a space or gap is undesired between respective ends 60 and 62 of antennas 56 and 54). Accordingly, while FIG. 3 illustrates two antennas 54 and 56, it should be understood that handle 10 may be configured having a greater or lesser quantity of antennas. In the embodiment illustrated in FIG. 3, handle 10 comprising antennas 54 and 56 is coupled to front wall 30 of display member 16. However, it should be understood handle 10 may be coupled to different locations of computer device 12 (e.g., elsewhere on display member 16 and/or on housing 19 of base member 14).

FIG. 4 is a diagram illustrating a portion of another embodiment of computer device 12 having multi-function handle 10 in accordance with the present invention. In the embodiment illustrated in FIG. 4, handle 10 is pivotably and/or rotatably coupled to display member 16 via hinges 64 and 66. In the embodiment illustrated in FIG. 4, handle 10 comprises antenna(s) 48 disposed therein; however, it should be understood that handle 10 itself could also be configured as an antenna (i.e., functions as and/or otherwise forms an antenna of a computer device 12 as illustrated and described in the embodiment of FIG. 3) or, in the alternative, can be configured without an antenna 48 (e.g., having cavity 44 therein for storage of other operational components of computer device 12 and/or storage of non-operational items (e.g., pencil, earphone, etc.)). Antenna(s) 48 are coupled to corresponding internal circuitry of computer device 12 through hinges 64 and/or 68 or otherwise, In the embodiment illustrated in FIG. 4, handle 10 is coupled to front wall 30; however, it should be understood that handle 10 may be pivotally coupled to different locations of computer device 12 (e.g., elsewhere on display member 16 and/or on housing 19 of base member 14).

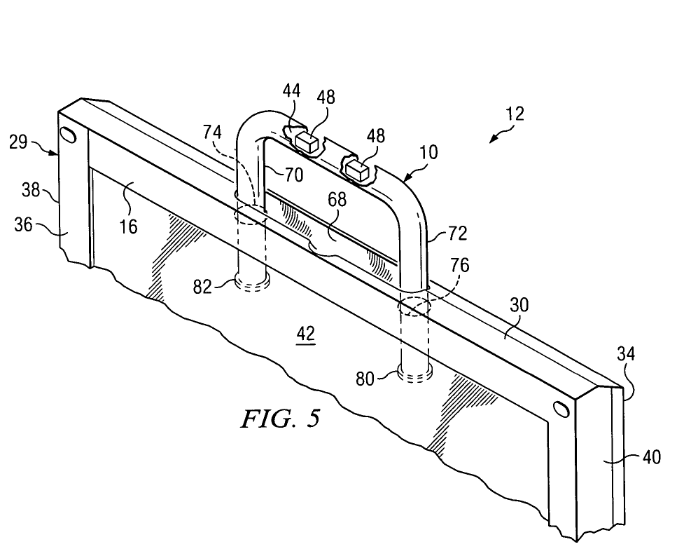

FIG. 5 is a diagram illustrating a portion of yet another embodiment of computer device 12 having multi-function handle 10 in accordance with the present invention. In the embodiment illustrated in FIG. 5, computer device 12 comprises a retractable handle 10 coupled to housing 29 (handle 10 being illustrated in at least a partially extended position in FIG. 5). In the embodiment illustrated in FIG. 5, housing 29 comprises a recessed area 68 to receive at least a portion of handle 10 when in a retracted position (e.g., to enable handle 10 to be positioned flush or substantially flush with surface 30 of housing 29), thereby enabling handle 10 to be positioned and/or otherwise stored within an outer envelope or periphery of housing 29. Preferably, handle 10 and/or housing 29 is configured such that frictional engagement between portions 70 and 72 of handle 10 and openings 74 and 76 formed in housing 29, respectively, enables handle 10 to remain in fixed positional relationship relative to housing 29 (e.g., in either an extended or retracted position). However, it should be understood that other methods and/or mechanisms may be used to enable handle 10 to remain in a desired position relative to housing 29. In the embodiment illustrated in FIG. 5, handle 10 comprises antenna(s) 48 disposed therein; however, it should be understood that handle 10 could also be configured as an antenna (i.e., functions and/or is otherwise formed as antenna of a computer device 12 as illustrated and described in the embodiment of FIG. 3) or, in the alternative, can be configured without antenna(s) 48 (e.g., having cavity 44 therein for storage of other operational components of computer device 12 and/or storage of non-operational items (e.g., pencil, earphone, etc.)). In the embodiment illustrated in FIG. 5, handle 10 is configured having stop members 80 and 82 to limit an amount of extension of handle 10 relative to housing 29 and/or otherwise prevent handle 10 from being disengaged from computer device 12. However, it should be understood that other methods and/or mechanisms may be used to limit an amount of extension of handle 10 relative to housing 29 and/or otherwise prevent handle 10 from being disengaged from computer device 12. In the embodiment illustrated in FIG. 5, handle 10 is coupled to front wall 30; however, it should be understood that handle 10 may be coupled to different locations of computer device 12 (e.g., elsewhere on display member 16 and/or on housing 19 of base member 14).

Thus, embodiments of the present invention provide a convenient storage location for operational component(s) 11 of computer device 12 and/or other items that may be used either in connection with the operation and/or use of computer device 12 or independently of computer device 12. Further, some embodiments of the present invention provide enhanced performance of computer device 12. For example, in some embodiments of the present invention, handle 10 is configured to house antenna(s) 48 of computer device 12 and/or function as an antenna (e.g., as illustrated and described in FIG. 3), and handle 10 is located on computer device 12 to be in an elevated position when computer device 12 is generally in an open condition and in use, thereby facilitating enhanced wireless communications of computer device 12. Embodiments of the present invention provide a handle 10 coupled to computer device 12 via hinges 64 and 66, or in the alternative, handle 10 can be retractable (e.g., as illustrated and described in FIG. 5). Further, embodiments of the present invention provide a convenient storage area for accessories within handle 10. In addition, embodiments of the present invention also provide an antenna directly couplable to housings 19 and/or 29.

What is claimed is:

1. A computer device comprising:
a handle usable to transport the computer device, the handle configured having a storage cavity disposed therein.

2. The computer device of claim 1, wherein the handle is disposed on a display member of a notebook computer device.

3. The computer device of claim 1, wherein at least one operational component of the computer device is disposed within the storage cavity.

4. The computer device of claim 1, wherein the handle is integrally formed on the computer device.

5. The computer device of claim 1, wherein at least a portion of the handle is disposed on a display member of a notebook computer device.

6. The computer device of claim 5, wherein at least another portion of the handle is disposed on a base member of the notebook computer device.

7. The computer device of claim 1, wherein an antenna of the computer device is disposed with the storage cavity.

8. The computer device of claim 1, wherein the handle comprises a plurality of handle portions adapted to cooperate with each other to form the storage cavity.

9. The computer device of claim 1, wherein the handle is configured as an antenna of the computer device.

10. The computer device of claim 1, wherein the handle is pivotally coupled to the computer device.

11. The computer device of claim 1, wherein the handle is retractable.

12. A method of manufacturing a computer device, comprising:
providing a handle usable to transport the computer device, the handle having a storage cavity disposed therein.

13. The method of claim 12, further comprising integrally forming the handle with a display member of a notebook computer device.

14. The method of claim 12 further comprising disposing at least one operational component of the computer device within the storage cavity.

15. The method of claim 12 further comprising integrally forming the handle with the computer device.

16. The method of claim 12, further comprising providing at least a portion of the handle on a display member of a notebook computer device.

17. The method of claim 16, further comprising providing at least another portion of the handle on a base member of the notebook computer device.

18. The method of claim 12, further comprising providing a plurality of handle portions adapted to cooperate with each other to form the storage cavity.

19. The method of claim 12, further comprising configuring the handle as an antenna of the computer device.

20. The method of claim 12, further comprising pivotally coupling the handle to the computer device.

21. The method of claim 12, further comprising retractably coupling the handle to the computer device.

22. A computer device, comprising:
a handle usable to transport the computer device, the handle configured as an antenna for the computer device.

23. The computer device of claim 22, wherein the handle is disposed on a display member of a notebook computer device.

24. The computer device of claim 22, wherein the handle comprises a plurality of antennas.

25. The computer device of claim 22, wherein the handle is retractably coupled to the computer device.

26. The computer device of claim 22, wherein the handle is pivotally coupled to the computer device.
